(19) United States
(12) Patent Application Publication
(10) Pub. No.: US 2014/0295822 A1
(43) Pub. Date: Oct. 2, 2014

(54) SYSTEMS AND METHODS FOR COOKING WITH A SMARTCOOK ARCHITECTURE

(71) Applicant: INTEL CORPORATION, Santa Clara, CA (US)

(72) Inventors: Nyuk Kin Koo, Pulau Pinang (MY); Yee Hong Tan, Perak (MY)

(21) Appl. No.: 14/129,768

(22) PCT Filed: Dec. 14, 2012
(86) PCT No.: PCT/US2012/069907

§ 371 Date: Dec. 27, 2013

(30) Foreign Application Priority Data
Dec. 19, 2011 (MY) PI 2011006164

(51) Int. Cl. H04W 8/24; H05B 1/02

(52) U.S. Cl. CPC H04W 8/24; H05B 1/02
USPC 455/420; 219/482

(57) ABSTRACT

Techniques for improving user's cooking experience with a SmartCook architecture are described herein. The SmartCook architecture includes a mobile device that is configurable to communicate via the Internet. The mobile device is also configurable to communicate via a SmartCook interface with a SmartCook appliance that is located within a close proximity. The techniques described herein leverage a graphical user interface (GUI) of the mobile device to monitor and control cooking operations of the SmartCook appliance.

### BACKGROUND

Consumer preference appears to be shifting away from eating fast food meals and carryout dinners and opting for healthier choices. With an increased awareness that ready-to-eat packaged foods and frozen TV dinners often contain preservatives, man consumers prefer to cook dishes that use fresh ingredients, are nutritious, and can be prepared using, quick and easy recipes. Several cooking appliances that can assist the consumer in preparing healthy dishes in a relatively short time are available on the market. Many of these cooking appliances use electronic controls that typically include preset buttons and alphanumeric LED displays to display status information.

With an increase in the number of vendors manufacturing, cooking appliances and each vendor providing tens of models, the task of learning and using electronic controls for each cooking appliance in a kitchen has become more complex for the consumer. For example, a simple task of adjusting a digital clock to account for daylight savings time change is often a frustrating experience. It may require the user: 1) to consult an instruction manual (if available), 2) read and follow the instructions, and 3) make the clock change. Often, time is wasted by using a trial and error or on-the-job training process to change the clock.

### BRIEF DESCRIPTION OF THE DRAWINGS

The detailed description is described with reference to the accompanying figures. in the figures, the left-most digit(s) of a reference number identifies the figure in which the reference number first appears. The same numbers are used throughout the drawings to reference like features and components.

FIG. 1 illustrates an example SmartCook architecture for cooking that includes networked smart cooking devices within which the techniques described herein may be implemented.

FIG. 2 is an example block diagram illustrating additional details of the mobile device described with reference to FIG. 1. The illustrated, portions implement SmartCook tools and techniques described herein.

FIG. 3 is an example block diagram illustrating additional details of the SmartCook appliance described with reference to FIG. 1. The illustrated portions implement SmartCook tools and techniques described herein.

FIGS. 4A, 4B, 4C, 4D, 4E and 4F are a series of example screen shots that illustrate additional details of the GUI of the mobile device described with reference to FIGS. 1 and 2.

FIG. 5 a flow diagram illustrating an example process to implement the techniques described herein for preparing a food dish.

### DETAILED DESCRIPTION

Applicants recognize that the user's experience of cooking tasty and healthy meals for feeding one's family and entertaining guests would he improved by developing customizable cooking application solutions that would provide walk-through guidance to the user to perform multiple tasks in a particular order for cooking the meal. The cooking application solutions address the challenges that often diminish the user's cooking, experience. For example, the user challenge of remembering how to interact with the cryptic electronic controls of an appliance such as preset buttons and alphanumeric LED displays for controlling and monitoring the cooking process may be addressed by using an intuitive, easy-to-use graphical user interface (GUI) display.

The user experience may be enhanced by using the GUI to manage the entire cooking and entertaining process from sending an invitation to friends and family for a dinner party (e.g., potluck activity), locating and purchasing fresh ingredients for the best value, to sharing the recipe for the award-winning gourmet dish with friends and family A SmartCook architecture that includes tools and techniques described herein offer solutions to improve the user's cooking and entertaining experience.

In a SmartCook architecture, a user may use a mobile device, such as a smartphone to purchase a customizable cooking application solution (simply referred to as a SmartCook App). The SmartCook App is similar to an App program developed for an Apple or Android or Windows cellular phone that may be purchased from an Internet App Store web site. The mobile device is configurable to perform a dual communications role of: 1) accessing Internet based services, and 2) communicating with a smart cooking appliance for performing cooking tasks. The SmartCook App uses the same intuitive, graphical user interface (GUI) display available on a mobile device to manage all cooking and Internet access related tasks. The GUI improves the user experience by bypassing the need to use the cryptic electronic controls used to interact with most appliances.

In a SmartCook architecture, a smart cooking appliance is configurable to wirelessly communicate with a mobile device using a communications standard that supports secure wireless communications over very short distances (e.g., distances of approximately 10 centimeters). The SmartCook techniques described herein enable the smart cooking appliance to: 1) bypass reliance on cryptic electronics controls that are used as a primary user interface, and 2) functionally replace the cryptic electronic controls with an intuitive GUI display generated by the SmartCook App of the mobile device.

This brief introduction, including section titles and corresponding summaries, is provided for the reader's convenience and is not intended to limit the scope of the claims, nor the proceeding sections.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B. then “X employs A or B” is satisfied under any of the foregoing instances. In addition, the articles “a” and “an” as used in this application and the appended claims should generally be construed to mean “one or more” unless specified otherwise or clear from context to be directed to a singular form.

### EXAMPLE SMARTCOOK ARCHITECTURE

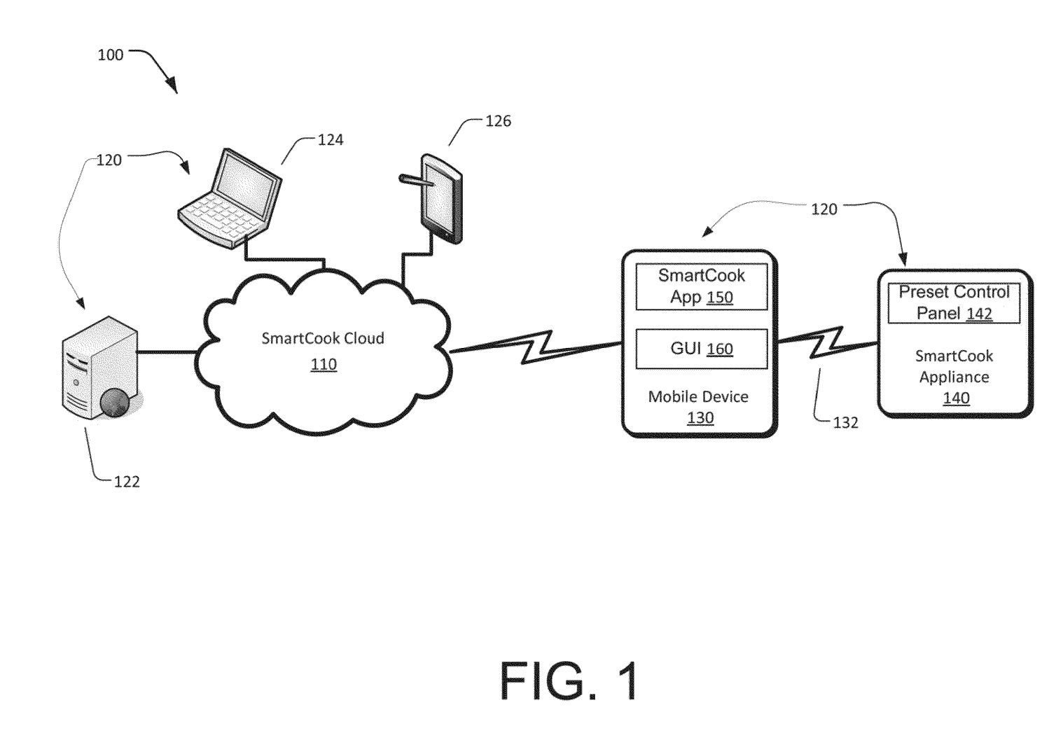

FIG. 1 illustrates an example SmartCook architecture 100. The example SmartCook architecture 100 may use a cloud computing model to deliver SmartCook products, services, and solutions over a communications network such as the Internet. It is understood that, unless otherwise stated, any communication network described herein may be implemented as a wired or wireless network.

A SmartCook cloud 110 may be configured to provide computation, software, data access, data storage, data security, content management, web site hosting, and similar other information technology (IT) services to computing devices 120 in a manner that is transparent to the user of the computing device. That is, the user may not need to have the knowledge of the physical location and configuration of the SmartCook cloud 110 that may be configured to deliver cooking related services as a utility (similar to a power grid that provides electricity to consumers) over the communications network such as the Internet

The SmartCook cloud 110 may he configured using IT components such as computers, networks, storage systems, databases, object oriented programming technologies, web hosting software, and similar others. Example computing devices 120 may include a server 122, a notebook 124, a tablet 126, a mobile device 130 (such as a smart phone), and similar others that are configured to communicate with the SmartCook cloud 110. Although not expressly shown in FIG. 1, each of the computing devices 120, including a SmartCook appliance 140, may include hardware, firmware, and/or software, which is configured to perform, at least in part, the techniques described herein.

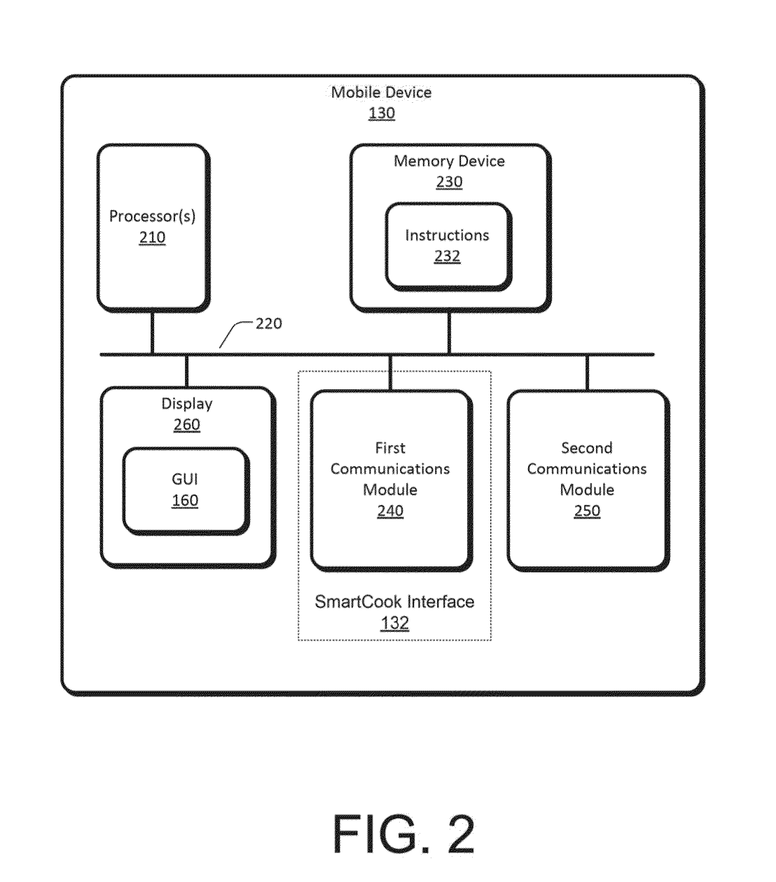

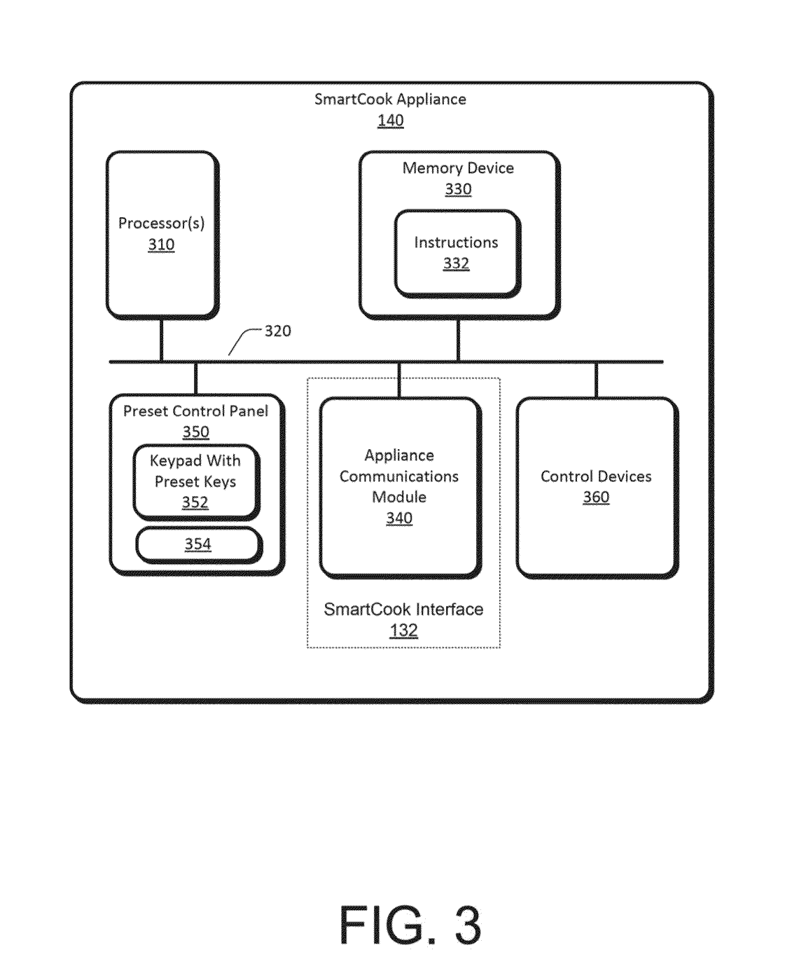

The SmartCook appliance 140 included in the SmartCook architecture 100 may be configured to wirelessly communicate with the mobile device 130 using a SmartCook interface 132. An example SmartCook interface 132 includes two components, one component which is included in the mobile device 130 and another component which is included in the SmartCook appliance 140. The SmartCook interface 132 may utilize a communications standard that may be designed for very short distance secure communications such as an encrypted near field communications (NEC) standard. Thus, information exchange between the SmartCook cloud 110 and the SmartCook appliance 140 may be enabled via the mobile device 130. Additional details of the mobile device 130 and the SmartCook appliance 140 are described with reference to FIG. 2 and FIG. 3 respectively,

The SmartCook cloud 110 may provide example cooking related tools and services such as recipe management software, listing SmartCook Applications (simply referred to as App's) for sale (similar to App's available on the Apple App store, Android Market store and Windows Marketplace store), and providing social media support to users. Services provided may include accessing, searching, storing, sharing, editing, purchasing, selling, and similar other activities related to cooking.

The social media support services may facilitate communication between various users participating in a SmartCook cloud 110 Examples of user participants may include users, manufacturers, service providers, buyers, SmartCook appliance user groups for specific brands/models, SmartCook appliance manufacturers group to share recipe information with buyers, and shoppers group to share information about ingredient shopping activities. Examples of social media web sites or networks that may be supported by the SmartCook cloud 110 may include Facebook™, Google™, Twitter™, MySpace™, etc.

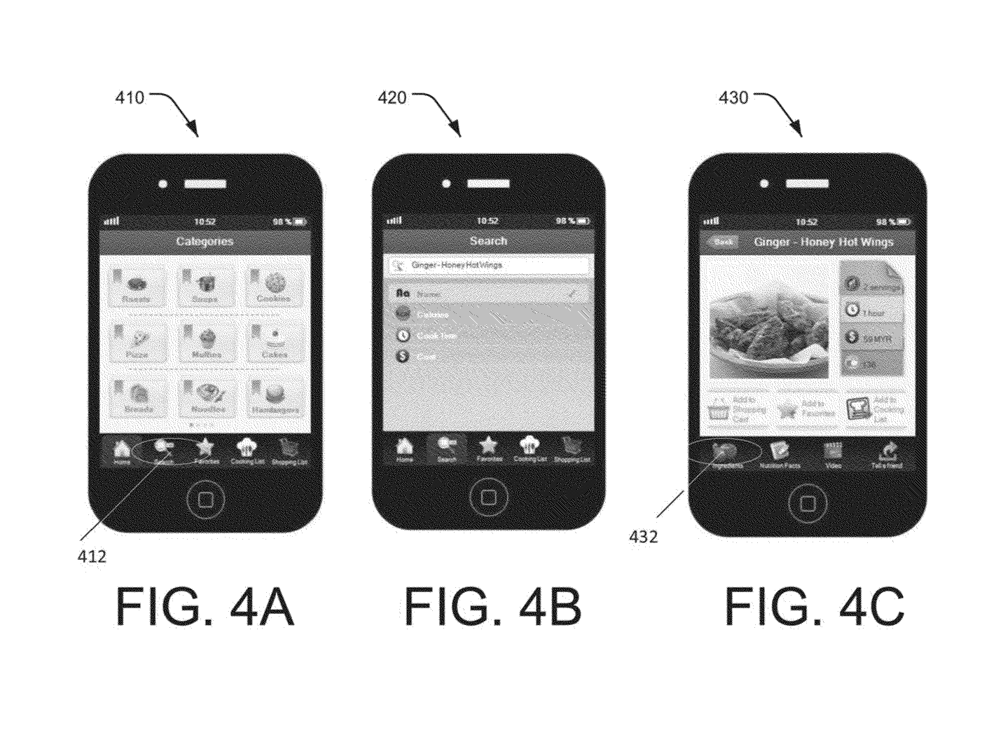

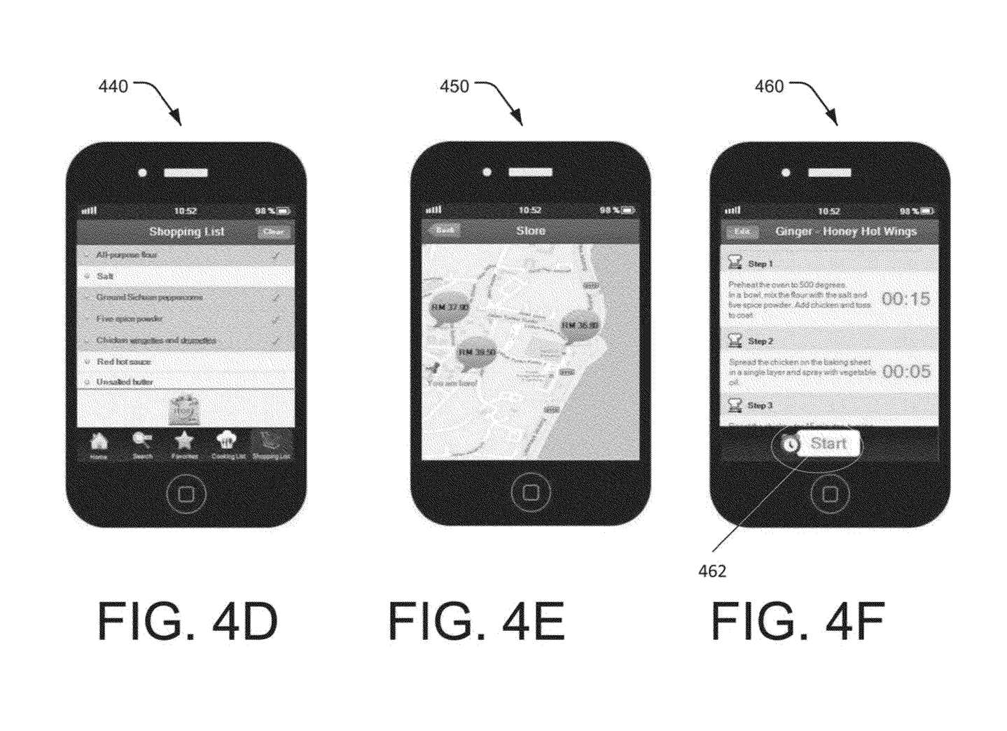

A SmartCook App 150 is a software program that may be purchased from an App store hosted by server 122 (similar to App stores marketed by Apple, Google, and Microsoft), downloaded to the mobile device 130, and launched for executed or activated) by a user action. The SmartCook App 150 leverages the intuitive and easy-to-use graphical user interface (GUI) 160 of the mobile device 130 for user interaction. The SmartCook App 150 customizes the GUI 160 for performing cooking related tasks or operations. Additional details of the GUI 160 to perform various cooking related tasks or operations are described with reference to FIGS. 4A, 4B, 4C, 4D, 4E and 4F.

Example tasks supported by the SmartCook App 150 may include Smartemik recipe management (e.g., searching for recipes on the Internet, generating new recipes, storing, and similar others), communicating with the SmartCook cloud 110 to share information (e.g., sharing recipes with friends and family), and communicating, with the SmartCook appliance 140 to transfer instructions (may also be referred to as commands) in accordance with the SmartCook recipe selection and to receive feedback information from the SmartCook appliance 140 regarding its operation. In addition to communicating the instructions to the SmartCook appliance 140, the GUI 160 of the mobile device 130 may also be used to configure parameters of the SmartCook appliance 140 such as adjusting date and time.

### EXAMPLE MOBILE DEVICE WITH DUAL COMMUNICATIONS

FIG. 2 is an example block diagram illustrating additional details of the mobile device 130 described with reference to FIG. 1. The mobile device 130, which is a type of a computing device or a computer system, includes a processor 210 coupled to a bus 220, a memory device 230 coupled to the processor via the bus 220, a first communications module (COM) 240 coupled to the processor 210 via the bus 220 a second COM 250 coupled to the processor 210 via the bus 220, and a display 260 coupled to the processor 210 via the bus 220. The display 260 is configured to provide the GUI 160 for user interaction. It should be understood that depending on the computing load more than one processor may be included in the mobile device 130. The memory device 230 is operable to store instructions or commands 232 that are executable by the processor 210 to perform one or more functions. It should be understood that the term “computer system” is intended to encompass any device having a processor that is capable of executing program instructions from a memory medium. Various functions, processes, method 500, programs, and operations described herein may be implemented using the mobile device 130.

The components of the mobile device 130 may be modules of computer-executable instructions, which are instructions executable on a computer, computing device, or the processors of such devices, While shown here as modules, the components may be embodied as hardware, firmware, software, or any combination thereof. The techniques described herein may be performed, as a whole or in part, by hardware, software, firmware, or some combination thereof.

The first COM 240, which forms one of the two components of the SmartCook interface 132, is configured to wirelessly communicate over very short distances using a first communication standard. The first communication standard may include a near field communications (NFC) standard configured to provide encrypted communications between any two NFC compliant devices. The first communication standard may also include the Bluetooth standard.

The processor 210 is operable to generate and store the instructions 232 by execution of the cooking application such as SmartCook App 150 for performing one or more predefined cooking tasks in the SmartCook appliance 140. The first COM 240 is configured to wirelessly communicate the instructions 232 to the SmartCook appliance 140 for execution.

The NEC standard compliant devices may be configured to automatically discover one another. The mobile device 130 may be configured to query the SmartCook appliance 140 and obtain its make, model, and other characteristics. The mobile device 130 may also be configured to query the SmartCook cloud 110 via the second COM and obtain instruction set and other attributes for a particular make and model of the SmartCook appliance 140.

Near Field Communication (NFC) is a very short-range wireless standard that enables encrypted, secure wireless communication between devices over a distance of approximately 10 centimeters. NEC is an International Organization for Standardization or ISO based standard. The ISO 14443 Type A and Type B standards+FeliCa is a four-part international standard for contact-less smart cards operating at 1156 MHz in close proximity with a reader antenna. The ISO 18092 standard defines communication modes for NEC Interface and Protocol. The NFC standard enables data transactions, data exchange, and wireless communications between two NFC compliant devices in close proximity to each other. Set up time for automatically pairing two NEC compliant devices is typically less than 1 millisecond.

The SmartCook interface 132 may also be configured to support wireless communications based on the Bluetooth standard. Compared to the NEC standard, the Bluetooth standard typically supports communication over longer distances (e.g., up to 10 meters) and requires a longer set up time (e.g., about 5-6 seconds).

The second COM 250 is configurable to wirelessly communicate with the SmartCook cloud 110 via the Internet using a second communication standard. The second communication standard may be based on IEEE 802.11 family of standards for wireless local area network (MAN). The mobile device 130 may also be configured to support IEEE 802.16 family of standards for wireless broadband devices such as 3G and 4G cell phones with WiMAX capability.

The mobile device 130 includes the display 260 such as a LCD or LED screen that is coupled to the processor 210 via the bus 220. The display device is configurable to provide the graphical user interface (GUI) 160 for user interaction such as launching a cooking application stored in the memory device 230.

### EXAMPLE SMARTCOOK APPLIANCE WITH WIRELESS COMMUNICATIONS

FIG. 3 is an example block diagram illustrating additional details of the SmartCook appliance 140 described with reference to FIG. 1. The SmartCook appliance 140, which is a type of a computing device or a computer system, includes a processor 310 coupled to a bus 320, a memory device 330 coupled to the processor via the bus 320, an appliance communications module (ACOM) 340 coupled to the processor 310 via the bus 320, and a preset control panel 350 coupled to the processor 310 via the bus 320. The memory device 330 is operable to store instructions 332 that are executable by the processor 310 to perform one or more functions.

The preset control panel 350 is configurable to interact with users by receiving user inputs and displaying information to the user. The example preset control panel 350 may include components such as rotary dials, selector knobs, membrane switches, keypad/touchpad with preset keys 352, and similar others. Activating each preset key of a keypad may cause the SmartCook appliance 140 to perform a corresponding preset function such as ‘baking’, ‘broiling’, ‘roasting’, ‘delayed start’, ‘defrosting’, ‘convention bake’, ‘quick freeze’, ‘turbo freeze’, ‘boiling’, and other cooking functions. The example preset control panel 350 may also include an alphanumeric LED display 354 to display cooking information in alphanumeric text form such as time remaining, temperature, self cleaning mode, and similar other. In a non-depicted, example embodiment, the preset control panel 350 may be configured to support wireless communications with the mobile device 130. That is, functionality of the ACOM 340 may be built into the preset control panel 350,

The ACOM 340, which forms the second of the two components of the SmartCook interface 132, may be configured to wirelessly communicate over short distances, e.g., approximity of about 10 centimeters, using the first communication standard described with reference to FIG. 2. As previously described, the first communication standard may include a near field communications (NFC) standard configured to provide encrypted communications between any two NFC compliant devices. The first communication standard may also include the Bluetooth standard.

A conventional appliance (not shown) that is equipped with a preset control panel and an alphanumeric display for user interaction may be upgraded to the SmartCook appliance 140 by simply adding the ACOM 340 to provide the SmartCook interface 132. By adding the SmartCook interface 132, the upgraded conventional appliance is enabled to communicate with the mobile device 130.

The processor 310 of the SmartCook appliance 140 is operable to execute instructions or commands 332 received from the mobile device 130 and perform actions by activating control devices 360 such as heater elements, timer elements, fans, and similar others to perform specified operations. The SmartCook appliance 140 may be configured to communicate via the ACOM 340 with the SmartCook App 150 to provide information (e.g., preheat operation is complete, temperature is at target value, and similar other) about itself.

The components of the SmartCook appliance 140 may be modules of computer-executable instructions, which are instructions executable on a computer, computing device, or the processors of such devices. While shown here as modules, the components may be embodied as hardware, firmware, software, or any combination thereof The techniques described herein may be performed, as a whole or in part, by hardware, software, firmware, or some combination thereof.

### EXAMPLE GUI FOR A SMARTCOOK APP

FIGS. 4A, 4B, 4C, 4D, 4E and 4F are a series of example screen shots that illustrate additional details of the GUI 160 of the mobile device 130 to guide the user in performing cooking related tasks and performing Internet access related tasks. The SmartCook App 150, which may be represented by an icon displayed on a screen and stored in the memory device 230 of the mobile device 130, may be launched or activated by the user (e.g., by using a touch screen or using a cursor point and click device).

Referring to FIG. 4A, in response to the launching of the SmartCook App 150, a multi-page, top level display 410 may list one or more categories of SmartCook recipes (referred to as a library of SmartCook recipes such as breads, roasts, soups, noodles, cookies, cakes, and similar others. A user may select one of the categories (e.g., by using a touch screen or using a cursor point and click device) to list sub-categories or individual SmartCook recipes. A search icon 412 may be activated to enable the user to conduct a search for a particular SmartCook, recipe stored within the library of SmartCook recipes or search available recipes on the Internet that match one or more selection criteria such as name, calories, cook time, cost or similar other search criteria.

Referring to FIGS. 4B and 4C, when a particular SmartCook recipe such as ‘ginger-honey hot wings’ is searched and selected by the user as shown in display 420, additional details of the recipe such as serving size, calories, time to prepare, and similar other attributes are displayed on the screen as shown in display 430. The user may also select any one of the icons displayed for each selected recipe such as listing ingredients, obtaining nutritional facts, or playing a video of how to prepare the food dish.

A SmartCook recipe fur a food dish, such as the one for ‘ginger-honey hot wings’ shown in display 430, may be specified in terms of listing ingredients and outlining a procedure. A quantity of each ingredient used may be specified depending on the serving size of the food dish. The procedure may specify an order of execution of predefined cooking tasks (may also be simply referred to as steps or operations) to prepare the food dish.

Examples of predefined cooking tasks may include ingredient processing operations performed by SmartCook food processors (e.g., blending, chopping, peeling, mixing, and similar others) and energy source control operations performed by SmartCook cooking appliances (e.g., pre-heating, baking, simmering, slow cooking, setting, timer, blending, chopping, mixing, whipping, peeling, and other cooking functions). Instructions to perform the recipe-specified operations such as pre-heating oven to 177 degrees Celsius, baking at 177 degrees Celsius for 30 minutes, and others may be generated by the mobile device 130, communicated to the SmartCook cooking appliance (e.g., oven) and executed by the SmartCook cooking appliance to complete cooking tasks defined by the SmartCook recipe.

In a cooking scenario where a user may be experimenting with a recipe or further refining a recipe by adjusting the cooking parameters such as cooking time or cooking temperature or rearranging an order of execution of the operations, the SmartCook App 150 may be configured to operate in a ‘record’ mode that can capture the changes made to the SmartCook recipe being executed and save it as a new SmartCook recipe for future use or sharing via the SmartCloud 110. By activating the ingredients icon 432, the GUI 160 may display a list of ingredients fur the selected SmartCook recipe along with the specified quantity. The user may drag and drop one or more ingredients listed that need to be purchased into a shopping cart.

Referring to FIG. 4D, on activating the shopping cart icon as shown or display 440, one or more retail stores which participate as a provider for the SmartCook marketplace and stocks the listed ingredients may be requested to bid on the shopping cart. An order may be placed by the user of the mobile device 130 to the retail store that offers the best value (i.e., lowest price).

Referring to FIG. 4E, if there are no participants available in the SmartCook marketplace or if the user selects the map icon, then the GUI 160 may display a map 450 of the nearest store that stocks the listed ingredients. A particular SmartCook recipe selected may be added to a list of favorites by using a drag and drop feature of the GUI 160. Similarly, one or more SmartCook recipes for preparing one or more food dishes that may be a part of a complete meal may be added to the cooking list.

Referring to FIG. 4F, a step-by-step procedure for the selected SmartCook recipe is displayed on the screen 460 when the SmartCook recipe is activated by the user. In the example display, step 1 is shown to include preheating the oven to 260 degrees Celsius. A time estimate to complete step 1 may also be displayed. In certain implementations, altitude may be accounted for. For example, different altitudes may affect the outcome of recipes. The GUI 160 may be used by the user to customize the SmartCook recipe that is displayed by modifying the order of execution one or more predefined cooking tasks. When the user is ready to proceed with the execution of the sequence of steps, the start icon 462 may be activated. This action generates instructions or commands to be communicated via the SmartCook interface 132 to the SmartCook appliance 140.

The instructions (or commands) 232 and 332 may be customized (e.g., customized for each brand name and model of the appliance) or they may be generic (e.g., applicable to virtually all brands and models) for execution by the SmartCook appliance 140 to perform the one or more operations that are listed in the SmartCook recipe. To customize instructions, the mobile device 130 may query the SmartCook appliance 140 to obtain self identification information and then modify the instructions communicated to the SmartCook appliance in response to receiving the self identification information.

In certain implementations, a profile may be implemented on the mobile device 130 that may include user location, such as altitude location. Therefore, such a profile may account for adjustments to recipes to account for location (e.g., altitude). The profile may also include all available SmartCook appliances, and non SmartCook appliances.

The SmartCook appliance 140 is operable to execute instructions received from the mobile device 130 and perform actions by activating control devices 360 such as heater elements, timer elements, fans, and similar others to perform the specified operation. The SmartCook appliance 140 may be configured to communicate with the SmartCook App 150 to provide information (e.g., preheat operation is complete, temperature is at target value, and similar other) about itself.

### EXAMPLE PROCESS

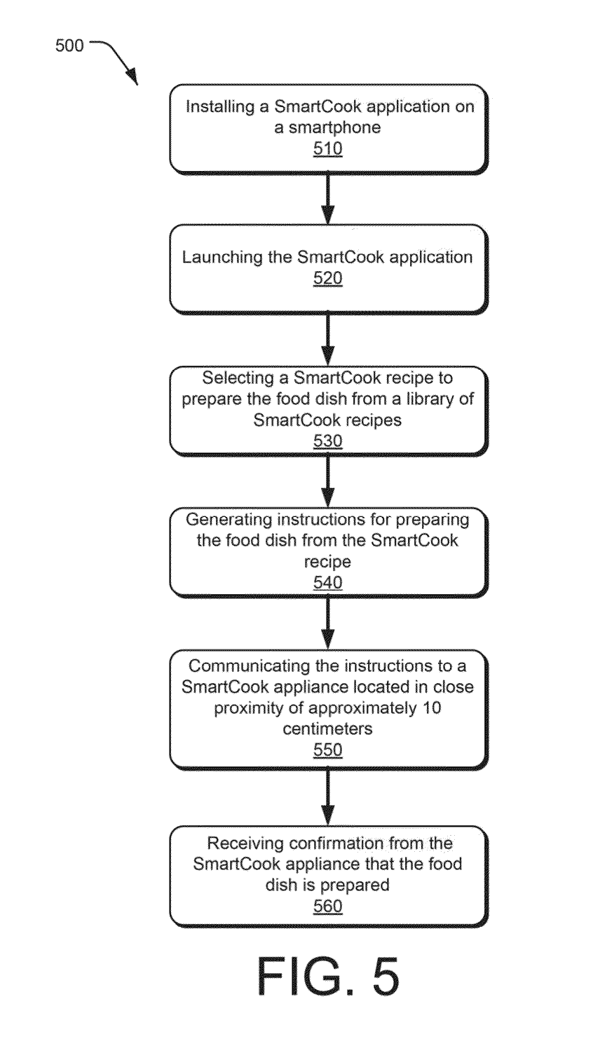

FIG. 5 is a flow diagram illustrating example process 500 that implements the techniques described herein for preparing a food dish. The process is illustrated as a collection of blocks in a logical flow graph, which represents a sequence of operations that can be implemented in hardware, software, or a combination thereof in the context of software, the blocks represent computer instructions that, when executed by one or more processors of such a computer, perform the recited operations. Note that the order in which the process is described is not intended to be construed as a limitation, and an number of the described process blocks can be combined in any order to implement the process, or an alternate process.

At process 510, a SmartCook application (e.g., the SmartCook App 150) is installed on a mobile device. The SmartCook App 150 may be purchased on the Internet e.g., from a server 122 using services supported by the SmartCook cloud 110, and stored in the memory device 230. At process 520, the SmartCook App 150 is launched by the user by clicking on its icon. At process 530, a SmartCook recipe is selected to prepare the food dish from a library of SmartCook recipes. As described with reference to FIG. 4B, display 420 may be used to conduct a search for a recipe by specifying recipe attributes such as name, calories, cooking time, and cost.

Referring back to FIG. 5, at process 540, instructions or commands for cooking the food dish from the SmartCook recipe are generated by the mobile device 130. At process 550, the instructions or commands are communicated by the mobile device 130 to the SmartCook appliance 140 that is located in close proximity of approximately 10 centimeters using the SmartCook interface 132. The instructions or commands are executable by the processor 310 of the SmartCook appliance 140 to cook the food dish. At process 560, the mobile device 130 is configured to receive information from the SmartCook appliance 140 that the cooking process is complete and the food dish is prepared.

1-21. (canceled)

22. A mobile device comprising:
a processor;
a memory device coupled to the processor;
a first communications module coupled to the processor, the first communications module being configured to wirelessly communicate using a first communication standard;
a second communications module coupled to the processor, the second communications module being configured to wirelessly communicate using a second communication standard; and
a display device coupled to the processor, the display device providing a graphical user interface for launching a cooking application stored in the memory device.

23. The mobile device of claim 22, wherein the first communication standard is a near field communications standard configured to provide encrypted communications between any two near field communications compliant devices.

24. The mobile device of claim 22, wherein the first communications module is configured to wirelessly communicate instructions to a SmartCook appliance, the instructions being generated by execution of the cooking application for performing one or more predefined cooking tasks in the SmartCook appliance, communications between the mobile device and the SmartCook appliance being compliant with the first communication standard.

25. The mobile device of claim 24, wherein the graphical user interface provides an intuitive display for user interaction, the graphical user interface being configurable to select an order of execution of the one or more predefined cooking tasks.

26. The mobile device of claims 24, wherein the cooking application is received via the Internet.

27. The mobile device of claim 24, wherein launching the cooking application loads a library of cooking recipes stored in the memory device, each cooking recipe comprising food ingredients and a procedure for setting an order of execution for the one or more predefined cooking tasks.

28. The mobile device of claim 24, wherein the cooking recipe is customizable by modifying the order of execution one or more predefined cooking tasks by using the graphical user interface.

29. The mobile device of any of claims 22, wherein the first communication standard implements a communication of 10 centimeters or less.

30. The mobile device of any of claims 22, wherein the communication through the second standard is through the Internet.

31. The mobile device of any of claims 22, wherein a profile is provided indicating location and available of SmartCook appliances and non SmartCook appliances.

32. A SmartCook appliance comprising:
a processor;
a control panel coupled to the processor, the control panel being configured to receive a user input, the processor operable to execute instructions to launch one or more predefined cooking tasks in response to receiving the user input; and
an appliance communications module coupled to the processor, the appliance communications module being configured to wirelessly communicate using a first communication standard, the processor being configured to receive the instructions via the appliance communications module.

33. The SmartCook appliance of claim 32, wherein the first communication standard is a near field communications standard configured to provide secure communications between any two near field communications compliant devices that are located within 10 centimeters.

34. The SmartCook appliance of claims 32, wherein the appliance communications module is configurable to wirelessly communicate with a mobile device using the first communication standard, the mobile device being configured to wirelessly communicate over the Internet using a second communication standard.

35. The SmartCook appliance of claim 34, wherein the instructions are generated by launching a cooking application stored in a memory of the mobile device.

36. The SmartCook appliance of claims 34, wherein the mobile device includes a display device for providing a graphical user interface for user interaction, the graphical user interface being configurable to select an order of execution of the one or more predefined cooking tasks, the graphical user interface replacing the user input for user interaction.

37. A mobile device for preparing a food dish, the mobile device comprising:
means for installing a SmartCook application on the mobile device;
means for launching the SmartCook application;
means for selecting a SmartCook recipe to prepare the food dish from a library of SmartCook recipes;
means for generating instructions for preparing the food dish from the SmartCook recipe; and
means for communicating the instructions to a SmartCook appliance located in close proximity of approximately 10 centimeters, the instructions being executable by the SmartCook appliance to prepare the food dish.

38. The mobile device of claim 37, wherein the means for communicating further comprising:
means for querying the SmartCook appliance to obtain self identification information;
means for modifying the instructions communicated to the SmartCook appliance in response to receiving the self identification information.

39. The mobile device of claim 37, further comprising:
means for modifying the SmartCook recipe prior to generating the instructions to generate a new SmartCook recipe;
means for storing the new SmartCook recipe; and
means for sharing the new SmartCook recipe with users via a social media network.

40. The mobile device of any of claims 37, wherein the means for selecting the SmartCook recipe further comprising:
means for searching the library of SmartCook recipes by matching a keyword.

41. At least one computer-readable medium having stored thereon instructions for preparing a food dish, the instructions being executable to cause a computer processor to:
install a SmartCook application on a mobile device;
launch the SmartCook application;
select a SmartCook recipe to prepare the food dish from a library of new SmartCook recipes;
generate commands for cooking the food dish from the SmartCook recipe; and
communicate the commands to a SmartCook appliance located in close proximity of approximately 10 centimeters, the commands being executable by the SmartCook appliance to cook the food dish.

42. The at least one computer-readable medium of claim 41, wherein the commands are customizable for execution by the SmartCook appliance.
